(19) United States
(12) Patent Application Publication
(10) Pub. No.: US 2019/0111560 A1
(43) Pub. Date: Apr. 18, 2019

(54) Robot And Method For Controlling Robots

(71) Applicant: Siemens Aktiengesellschaft, Munchen (DE)

(72) Inventor: Werner Neubauer, München (DE)

(73) Assignee: Siemens Aktiengesellschaft, Munchen (DE)

(21) Appl. No.: 16/156,307

(22) Filed: Oct. 10, 2018

(30) Foreign Application Priority Data
Oct. 13, 2017 (EP) 17196389.5

(51) Int. Cl. B25J 3/00; B25J 9/00

(52) U.S. Cl. CPC B25J 3/00; B25J 9/0084

(57) ABSTRACT

Various embodiments include a method for controlling an arrangement of a first robot and a second robot comprising: controlling the first robot with a first control process; and controlling the second robot with a second control process. During a first period of a work operation, movements of the first robot and the second robot are matched to one another and, during a second period of the work operation, are carried out independently.

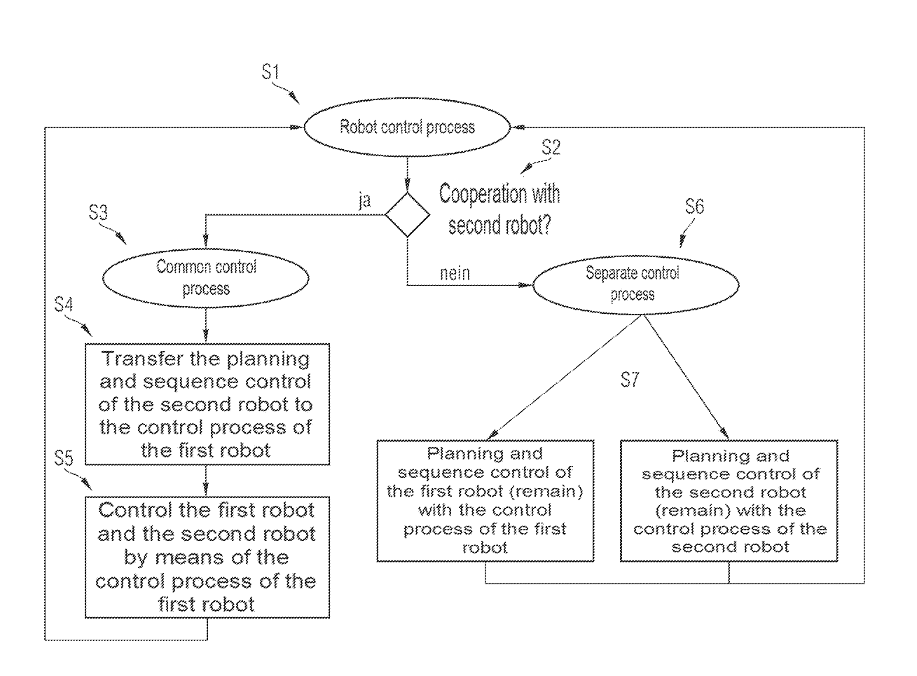

### CROSS-REFERENCE TO RELATED APPLICATIONS

This application claims priority to EP Application No. 17196389.5 filed Oct. 13, 2017, the contents of which are hereby incorporated by reference in their entirety.

### TECHNICAL FIELD

The present disclosure relates to robots. Various embodiments may include a method for controlling an arrangement of a first robot and at least one second robot.

### BACKGROUND

Robots are used for carrying out work, in particular in the industrial environment but also increasingly in the medical or domestic sector. In the industrial sector in particular, the sequences to be performed in an automated manner for the respective use are generally stored in the robot by means of programming. The standard method of programming robots is nowadays still that of permanently programming the movements manually using the so-called teach-in technique (also known as “teaching”), in which desired positions are approached within working cycles and their coordinates are stored for the control process, as well as the sequences.

Control paradigms, in which the sequences and movements are generated automatically, are finding their way into more and more applications. This is carried out, on the one hand, in the off-line programming environment and also, on the other hand, online when performing the robot functions on the basis of sensor signals.

In this case, the methods for generating sequences and movements are either planning systems and/or simple to complexly programmed skills which control the robot systems, wherein a decision is made on the sequence online in this case, that is to say during performance. In this case, robot systems may already provide basic skills ex works which are then connected and parameterized by a system integrator in order to define the overall functionality. On account of the fact that a plurality of robots are used, inter alia in the industrial environment, there is the risk of collisions. In this respect, it is known practice to use sensors which detect other robots and/or other obstacles and adjust movements, if necessary. However, a joint use of robots with this solution is regularly subject to interruptions.

### SUMMARY

The teachings of the present disclosure may provide a solution which overcomes the disadvantages of the prior art. For example, some embodiments include a method for controlling an arrangement of a first robot and at least one second robot, in which the first robot is controlled by means of one control process and the second robot is controlled by means of a second control process, characterized in that the first and second control processes are configured in such a manner that, during at least one first period of a work operation, coupling is carried out in such a manner that movements of the robots are carried out in a manner matched to one another, in particular at the same time, and are carried out independently during at least one second period of the work operation.

In some embodiments, the first control process is carried out as a first process and the second control process is carried out as a second process by means of a central control process.

In some embodiments, the first and second control processes are carried out in a manner coupled to one another in such a manner that the first process and the second process are matched by the central control process.

In some embodiments, the first control process is carried out as a first process and the second control process is carried out as a second process on the respective robot.

In some embodiments, the first and second control processes are carried out in a manner coupled to one another in such a manner that the matching is carried out in the manner of the master-slave principle, wherein the first process is operated as the so-called “master” and the second process is operated as the so-called “slave”.

In some embodiments, sequence planning and sequence control of the work operation are carried out within the scope of the first and/or second control process.

In some embodiments, the coupling is initiated by capturing when the second robot enters the effective radius of the first robot and/or the first robot enters the effective radius of the second robot.

In some embodiments, the first robot is operated as a stationary cell and the second robot is operated as a mobile unit, wherein the coupling is initiated by docking the second robot to the robot cell of the first robot.

As another example, some embodiments include a robot, characterized by means for carrying out the method as described above.

### BRIEF DESCRIPTION OF THE DRAWINGS

Exemplary embodiments and further details of the teachings herein are explained below on the basis of the single drawing, in which the FIGURE schematically shows a flowchart of the method as an exemplary embodiment of a robot control process incorporating teachings of the present disclosure.

### DETAILED DESCRIPTION

In some embodiments, a method incorporating teachings of the present disclosure for controlling an arrangement of a first robot and at least one second robot, in which the first robot is controlled by means of one control process and the second robot is controlled by means of a second control process, the first and second control processes are configured in such a manner that, during at least one first period of a work operation, coupling is carried out in such a manner that movements of the robots are carried out in a manner matched to one another, in particular at the same time, and are carried out independently during at least one second period of the work operation.

Various methods allow a plurality of robots to at least temporarily carry out activities at the same time. A common working space is produced for phases of simultaneous work, whereas the robots can act in independent working spaces for the other times. This enables higher flexibility and a more efficient use of robots. For example, stationary robots could be assisted by mobile robots in (partial) work steps and could also be left again upon completion of this work. Working groups of purely mobile robots which form are also conceivable. However, the teachings may be used even in the case of stationary groups of robots which previously always acted in independent working spaces and therefore were not available for any simultaneous work.

In some embodiments, the first control process is carried out as a first process and the second control process is carried out as a second process by means of a central control process. This is a form of the method which can be implemented well since the processes can be at least temporarily supplied to the processing by one or more processors depending on the further configuration or development. Further flexibilization therefore arises.

In some embodiments, the first and second control processes may be carried out in a manner coupled to one another in such a manner that the first process and the second process are matched by the central control process. A central control process exhibits an advantage, inter alia, when the work sequences and plans have previously been effected for an interacting plurality of robots and, in the event of necessary adaptations, for example over the course of optimization, it also subsequently has to be carried out only at one location.

In some embodiments, the first control process is carried out as a first process and the second control process is carried out as a second process on the respective robot. This allows a greater independence of the robots, for example, which could be required in mobile robots, in particular.

In some embodiments, the first and second control processes are carried out in a manner coupled to one another in such a manner that the matching is carried out in the manner of the master-slave principle, wherein the first process is operated as the so-called “master” and the second process is operated as the so-called “slave”. The creation of such a hierarchical architecture or distribution of roles achieves a clear distribution of tasks, which promotes, inter alia, autonomy of the robots (robot groups).

In some embodiments, sequence planning and sequence control of the work operation are carried out within the scope of the first and/or second control process. If the coupling is initiated by capturing when the second robot enters the effective radius of the first robot and/or the first robot enters the effective radius of the second robot, a suitable trigger is provided in order to start the method according to the invention and is supported in its flexibility with respect to the number and organization of robots working on a (partial) task. In this case, the effective radius may be the space in which the robot can act and/or the space in which communication with the other robots is possible, in particular in a wireless manner.

In some embodiments, the first robot is operated as a stationary cell and the second robot is operated as a mobile unit, wherein the coupling is initiated by docking the second robot to the robot cell of the first robot, provides an alternative or additional configuration of the invention which makes it possible to sensibly trigger the coupling.

In some embodiments, a robot incorporating teachings of the present disclosure includes means for carrying out the method and/or the developments of the method and therefore contributes to achieving the advantages mentioned there.

The FIGURE schematically illustrates a sequence of an exemplary embodiment of the robot control process according to the invention, which shows an example of the principle according to the invention in the control process from a starting state “robot control process” referred to as the first step S1. A robot in this state will wait for trigger signals which initiate its activities, for example.

In this case, starting from this basic state, an evaluation is carried out, for example, in a second step S2 in order to determine whether the trigger signal indicates cooperation with one or more further robots, wherein a communication interface is required for this purpose, the configuration of which interface can be optionally formed depending on the desired design of the robots, in particular according to common communication standards.

If the evaluation in the second step S2 reveals that there is cooperation with a second robot at least as of this time, for example for a limited time, the robot control process according to the exemplary embodiment changes to a state “common control process” in a third step S3.

In some embodiments, this state can be characterized by at least one fourth step S4 in which the planning of the work steps and the control of the second robot, for example handled via the common communication interface, are transferred to the control, that is to say the control process, of the first robot, with the result that the latter undertakes the planning and control for both robots in a fifth step S5, with the result that, according to the master-slave principle, a distribution is achieved such that the first robot or its control process is the master or master process, whereas the second robot or its control process assumes the role of a slave or slave process. In this case, the roles can be divided in a permanently predefined manner by means of appropriate implementation, as a development, or adaptively depending on the activity which occurs or the (partial) process of the work to be carried out which occurs.

After this transfer, the robots are in the state in the first step S1, in which the joint work of two or more robots is now controlled according to the example until a further trigger signal in the second step S2 causes a change from joint work to the work of the first robot on its own. If such a trigger signal occurs, the method according to the invention is continued in such a manner that the control process changes to a state “separate control process” in a sixth step S6.

This state is at least characterized by a seventh step S7 in which the first robot on its own is controlled by the control process of the first robot and in which the control process of a second robot or of further robots respectively remains in the control processes of these robots in a parallel manner.

Advantages, further details and configuration variants of the exemplary embodiment and of the invention are as follows:

In some embodiments, a plurality of robot systems cooperate, with the result that their skills can be combined. In this case, the individual systems can also occasionally act individually. As a result, the use of robots is more effective, in particular in the industrial environment. The result is also an improved flow of the work carried out or of the movements of the robots.

In some embodiments, different working spaces in which only one robot can move in each case are defined for this purpose, for example. The alternating release of the movements or work carried out is effected via a superordinate control computer.

In some embodiments, in the case of a cooperative task, for example for two robots, for example during the two-armed installation of a component, the performance is considerably more efficient if both robot arms can simultaneously move in the same working space, at least occasionally.

This may even be necessary for some applications. So that the coordination is maintained and there are no collisions, the sequences and movements are planned together or are controlled together in a synchronous manner according to embodiments of the invention. For this purpose, as a result of the implementation of the teachings herein, the robots involved are connected functionally and possibly also structurally to one another and are operated in such a manner that the robots can be considered to be a system, the state space of which consists of the union of the state spaces of both robots.

In some embodiments, the planning and the control of the two robot systems change between two modes depending on whether the robot systems cooperate closely in one working space or work independently of one another in different working areas:
1) two separate control processes with separate planners and separate sequence control
2) a common control process with one planner and sequence control.

The common control process can be considered to be virtual in this case. That is to say, it is possible to arbitrarily determine where the planning is calculated in the second case, depending on the exemplary embodiment. For example, either everything is calculated in one control process and the performance of the other robot system is then carried out in the master-slave principle, as is the case in the exemplary embodiment illustrated, or the two control processes share the common task.

This changeover between the two modes can be temporarily carried out at any time during the performance of a task. This can be implemented in such a manner that the overall task is subdivided into individual temporal sections in which a partial task is carried out together or independently of one another.

For example, a mobile robot which docks at a stationary robot cell can be planned and controlled by a common virtual control process for the interaction time according to the invention. The necessary communication interface can also be provided, for example in a wired manner, via the docking, for example. However, wireless connection and therefore communication are also possible within the scope of the configurations.

In some embodiments, the cooperation of two or more robots may be considerably more efficient since both movements can be planned at the same time in the same working space. Mobile robots, in particular, are enriched with further possibilities and types of use by virtue of the invention since they can temporarily cooperate with one another or with a stationary robot cell as a result of the invention. The complexity arising from the synchronization and interaction of two control processes operating independently of one another can be avoided by means of the invention.

The alternating modes of the common planning and control not only allow the common movements to be carried out in an optimum manner, but the separate tasks are then also performed in an optimum manner independently of one another. The teachings herein also satisfy the need arising from the increased use of sensors and the resulting need to plan and perform the sequences and movements online. One possible field of use of mobile robots would be in the transport of materials, in particular, where they can also interact with stationary robot systems and can be dynamically grouped for cooperative tasks.

The embodiments described also stand out positively from block processing, in which particular working spaces are released only for one robot in each case, since, just like the avoidance of collisions, it at least temporarily inhibits the workflow. An efficient solution to the automation problem is not possible under block processing. The teachings herein are not restricted to the exemplary embodiments shown and discussed. Rather, it comprises all configurations defined by the claims.

1. A method for controlling an arrangement of a first robot and a second robot, the method comprising:
controlling the first robot with a first control process; and
controlling the second robot with a second control process;
wherein, during a first period of a work operation, movements of the first robot and the second robot are matched to one another and, during a second period of the work operation, are carried out independently.

2. The method as claimed in claim 1, wherein the first control process and the second control process are executed by a central control process.

3. The method as claimed in claim 2, wherein the first control process and the second control process are coupled to one another and matched by the central control process.

4. The method as claimed in claim 1, wherein the first control process and the second control process are carried out on the first robot.

5. The method as claimed in claim 4, wherein the first control process and the second control process are coupled to one another in a master-slave arrangement, wherein the first process operates as the master process and the second process operates as the slave process.

6. The method as claimed in claim 1, wherein at least one of the first control process and the second control process includes sequence planning and sequence control of the work operation.

7. The method as claimed in claim 1, wherein coupling is initiated when the second robot enters an effective radius of the first robot.

8. The method as claimed in claim 7, wherein:
the first robot comprises a stationary cell and the second robot comprises a mobile unit; and
coupling is initiated by docking the second robot to the robot cell of the first robot.
